(19) United States
(12) Patent Application Publication
(10) Pub. No.: US 2012/0169901 A1
(43) Pub. Date: Jul. 5, 2012

(54) Electronic apparatus, image capturing device and method for automatically capturing image thereof

(75) Inventor: Szu-Yi Chang, Tainan City (TW)

(73) Assignee: Altek Corporation, Hsinchu (TW)

(21) Appl. No.: 13/044,153

(22) Filed: Mar. 9, 2011

(30) Foreign Application Priority Data
Dec. 29, 2010 (TW) 099146674

(51) Int. Cl. H04N 9/68

(52) U.S. Cl. 348/238; 348/E09.053

(57) ABSTRACT

An electronic apparatus, an image capturing device and a method for automatically capturing an image thereof are disclosed. The image capturing device comprises an image capturing module, a sensing module and a processing module. The image capturing module is used to capture an image corresponding to a scene through a capturing window. The sensing module senses a brightness value of the scene. The processing module is used to divide the capturing window into a plurality of blocks, and control the sensing module to decide whether the brightness value of each block has been changed. When the brightness value of any block has been changed, the processing module controls the image capturing module to capture the image.

### BACKGROUND OF THE INVENTION

1. Field of the Invention

The present invention relates to an image capturing device and a method for automatically capturing images, and more particularly to an electronic apparatus, an image capturing device and method for automatically images by sensing a brightness variation of a taken scene.

2. Description of the Related Art

Presently, in a conventional image capturing device, it is not easy for a user to take light-shadow phenomena of a scene, because natural phenomena may not be predicted and the user may not instantly react to specific light-shadow to be taken. Consequently, the user is unable to take desired images (e.g. lightning).

Besides, to catch instantly brilliant lightning, a photographer intending to take a picture of lightning often has to stay for a long time to catch lightning. The photographer that takes a picture of lightning relies upon manual operation. If the photographer would like to take the picture of lightning, the user may acquire lightning forecast by different paths of detecting lightning of whole world such as satellite detection, a lightning instrument on the ground of each country and area or entire surveillance networks.

However, although the user can obtain timing of generating lightning through the foregoing manners, this manual operation has the following defects: (1) lightning environments may endanger the user while waiting lightning; (2) An background light of a photographing location may need long time exposure while taking a picture of lightning; (3) photographing timing: when the user press a camera shutter at the sight of lighting, lightning may disappear before an aperture of an image capturing device is opened.

Accordingly, designing an electronic apparatus, an image capturing device and a method for automatically capturing images capable of sensing a brightness and brightness variation of environments real-time and utilizing the sensed brightness variation to capture images become an important issue in markets.

### SUMMARY OF THE INVENTION

In view of the shortcomings of the prior art, the inventor(s) of the present invention based on years of experience in the related industry to conduct extensive researches and experiments, and finally developed an electronic apparatus, an image capturing device and its method for automatically capturing images to overcome problems in which a user may not predict light beam variation in nature since he/she would like to take light beam variation (e.g. lightning) in environments, and in which he/she is too late to catch predetermined frame when the user would like to press a camera shutter due to brightness variation.

To achieve the foregoing objective, an image capturing device of the invention is provided and comprises an image capturing module, a sensing module and a processing module. The image capturing module is used for capturing an image corresponding to a scene through a capturing window. The sensing module is used for sensing a brightness value of the scene. The processing module divides the capturing window into a plurality of blocks and controls the sensing module to decide whether or not the brightness value of each block is changed. When the brightness value of any one block is changed, the processing module controls the image capturing module to capture the image.

Preferably, the image capturing device further may comprise a setting module which is electrically connected to the processing module. The setting module is used for setting a threshold value. When a brightness variation of any one block is larger than the threshold value, the processing module controls the image capturing module to capture the image.

Preferably, when the brightness variation is larger than the threshold value, the processing module controls the image capturing module to capture a plurality of temporary images and perform image synthesis for the plurality of the temporary images.

Preferably, the setting module further sets a sensing scope. The sensing module senses a brightness value of the sensing module. The processing module divides the sensing scope into a plurality of blocks. When the brightness value of any one block is changed, the processing module controls the image capturing module to capture the image.

Preferably, the image capturing device further may comprise a touch module which is electrically connected to the setting module. The touch module receives at least one touch signal to allow the setting module to set the sensing scope based upon at least one touch signal.

To achieve the forgoing objective, an electronic apparatus is further provided and comprises an image capturing module, a sensing module, a display module, an input module and a processing module. The image capturing module captures an image corresponding to a scene. The sensing module senses a brightness value of a scene. The display module displays a captured frame. The input module is operated to provide an operating instruction. The processing module is electrically connected to the image capturing module, the sensing module, the input module and the display module. The processing module divides the captured frame into a plurality of blocks based upon the operating instruction and controls the sensing module to decide whether or not the brightness value of any one block is changed. When the brightness value of any one block is changed, the processing module controls the image capturing module to capture the image.

To achieve the forgoing objective, a method for automatically capturing images is provided and applied to an image capturing device. The method for automatically capturing images comprises the following steps: capturing an image corresponding to a scene through a capturing window; sensing a brightness value of the scene; dividing the capturing window into a plurality of blocks and sensing whether or not the brightness value of any one block is changed. When the brightness value of any one block is changed, image capturing device captures the image.

Preferably, the method may further comprise the following steps of setting a threshold; and capturing the image when the brightness variation of any one block is larger than the threshold value.

Preferably, the method may further comprise the following steps of capturing a plurality of temporary images when the brightness variation is larger than the threshold value and performing image synthesis for the plurality of temporary images.

Preferably, the method may further comprise the following steps of setting a sensing scope; and sensing the brightness value of the sensing scope.

The image capturing device and the method for automatically capturing images have one or more following advantages:
(1) The electronic apparatus, the image capturing device and its method for automatically capturing images can sense the brightness and the brightness variation of each block of the scene to automatically capture the image having brightness variation with respect to a user that would like to capture images corresponding to a scene having brightness variation.
(2) The electronic apparatus, the image capturing device and its method for automatically capturing images can determine whether or not the brightness variation of the scene is caught by the user by setting the threshold value so that the electronic apparatus, the image capturing device and its method for automatically capturing images can automatically determine the brightness variation that would like to be taken by the user to automatically capture the image.

### BRIEF DESCRIPTION OF THE DRAWINGS

FIG. 1 is a block diagram of an image capturing device according to an embodiment of the present invention;

FIG. 2 is a schematic diagram of an image capturing device according to an embodiment of the present invention;

FIG. 3 is a schematic diagram of an image capturing device according to another embodiment of the present invention;

FIG. 4 is a block diagram of an electronic apparatus according to an embodiment of the present invention;

FIG. 5 is a first flowchart of a method for automatically capturing images according to the present invention; and

FIG. 6 is a second flowchart of a method for automatically capturing images according to the present invention

### DETAILED DESCRIPTION OF THE PREFERRED EMBODIMENTS

The foregoing and other technical characteristics of the present invention will become apparent with the detailed description of the preferred embodiments and the illustration of the related drawings.

An image capturing device of the invention can be different types of portable electronic devices having image capturing function such as a digital camera, a camera phone, a personal digital assistant (PDA) or a digital video camera. To understand the technical features of the invention, a following takes, but does not limit to, the digital camera as an embodiment.

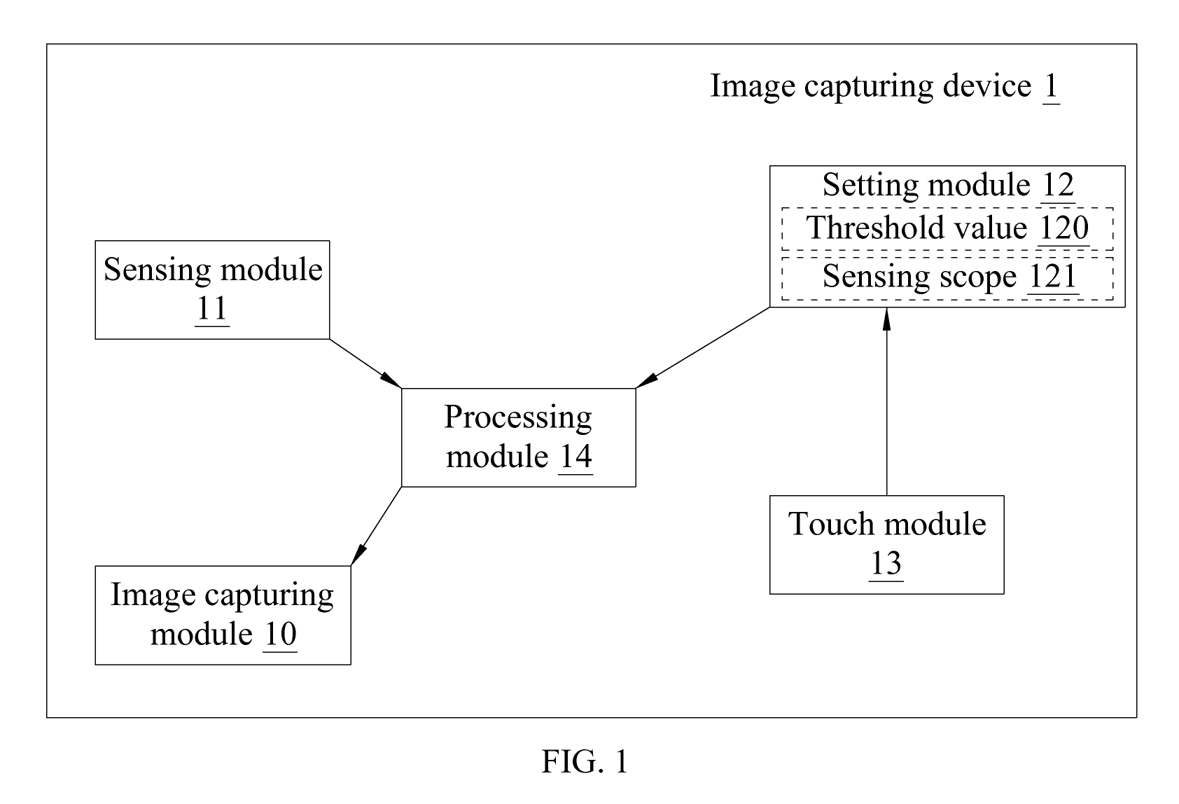

With reference to FIG. 1 for a block diagram of an image capturing device in accordance with an embodiment of the invention is depicted. The image capering device 1 of the invention comprises an image capturing module 10, a sensing module 11, a setting module 12, a touch module 13 and a processing module 14. The image capturing module 10 can include a lens, a photosensitive element such as a complementary metal-oxide-semiconductor (CMOS) or a charge-coupled-device (CCD), an analog/digital circuit, and an image processor. The sensing module 11 can be one or a plurality of surrounding brightness sensors. The surrounding brightness sensors can include photoelectric diodes, photoelectric transistors (bi-poles type or MOS type), photoelectric cells, and/or one photo resistor type brightness sensor. The touch module 13 is electrically connected to the setting module 12. The touch module 13 can be a capacitance type touch module, an optical touch module or a resistance type touch module. The processing module 14 is electrically connected to the image capturing module 10, the sensing module 11, and the setting module 12 and can be a central processing unit (CPU) or a micro-processing unit.

The image capturing module 10 captures an image corresponding to a scene through a capturing window. The sensing module 11 senses a brightness value of the scene. The setting module 12 sets a threshold value 120 so that the threshold value 120 is utilized to allow the processing module 14 to determine whether or not the image is captured. The touch module 13 allows a user to catch any area of the capturing window to allow the setting module 12 to set a sensing scope 121 based upon the area caught by the user. In the meantime, the sensing module 11 only senses the brightness value and a brightness variation of the sensing scope 121. The processing module 14 divides the capturing window (or the sensing scope 121) into a plurality of blocks and controls the sensing module 11 to decide whether or not a brightness value of each block is changed. When a brightness value of any block is changed, the processing module 14 controls the image capturing module 10 to capture the image.

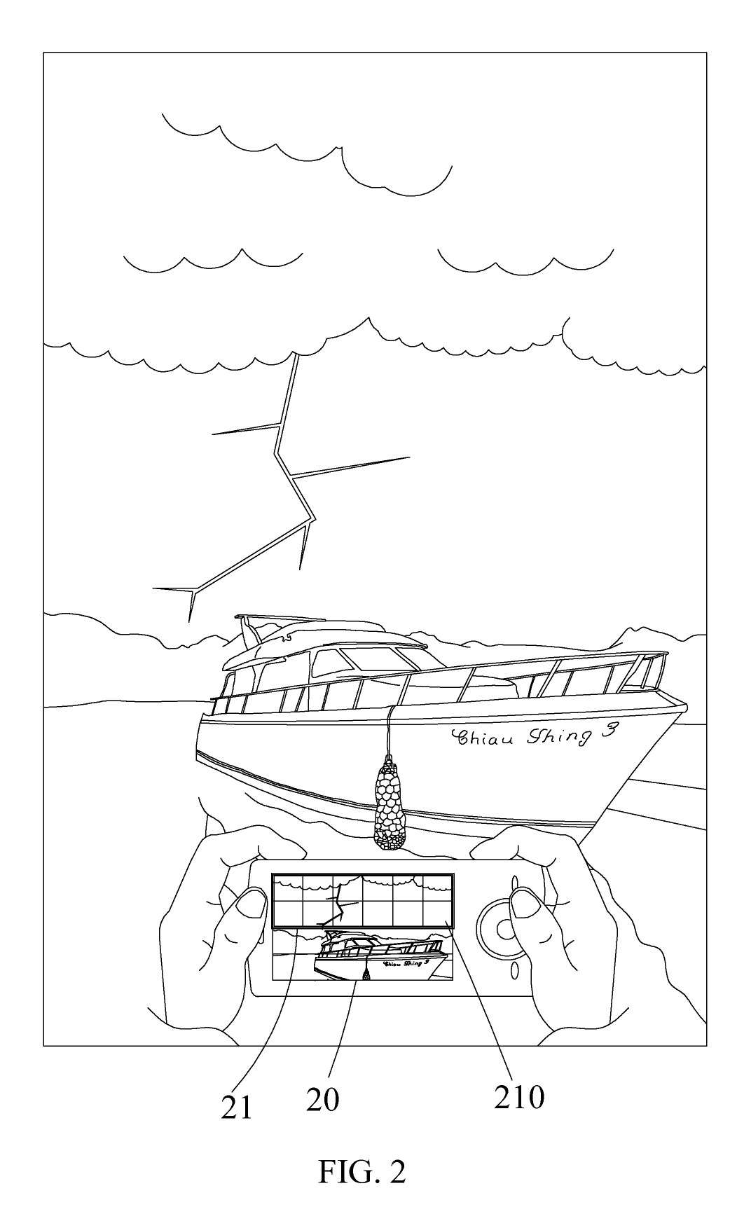

With reference to FIG. 2 for a schematic diagram of an image capturing device in accordance with an embodiment of the invention is depicted. As shown in FIG. 2, the image capturing device 1 of the invention can be a digital camera. In the embodiment, a user would like to capture images corresponding to a scene through the capturing window 20, wherein the scene can be a place having violent brightness variation such as a lightning place. A brightness value corresponding to the scene can be measured by the sensing module 11. When a lightning occurs, the brightness value of the scene is violently changed. The processing module 14 controls the image capturing module 10 to capture images based upon violent variation of the brightness value so as to obtain an image including lightning. In a preferred embodiment, the setting module 12 can be utilized to set the scope (as the sensing scope 21) of sensing the brightness value such that an area (e.g. building portions) that does not need to sense the variation of the brightness value can be ignored by the sensing module 11 to save electricity and resource. Further, the touch module 13 can be utilized to catch any area of the capturing window 20 to allow the caught area becoming a sensing scope 21. Accordingly, the user can utilize the touch module 13 to catch the sensing scope 21, and the sensing module 11 is controlled by the setting module 12 to merely sense the brightness value of the sensing scope 21. The processing module 14 can divide the sensing scope 21 into a plurality of blocks 210 and control the sensing module 11 to decide whether or not the brightness value of each block 210 is changed. When a brightness value variation of any one block 210 is greater than a threshold 120, the processing module 14 controls the image capturing module 10 to capture the image so that the user can take the image containing a desire brightness variation. When the brightness value variation is smaller than the threshold, the processing module 14 does not deliver a command of capturing images to the image capturing module 10 to save electricity and resource.

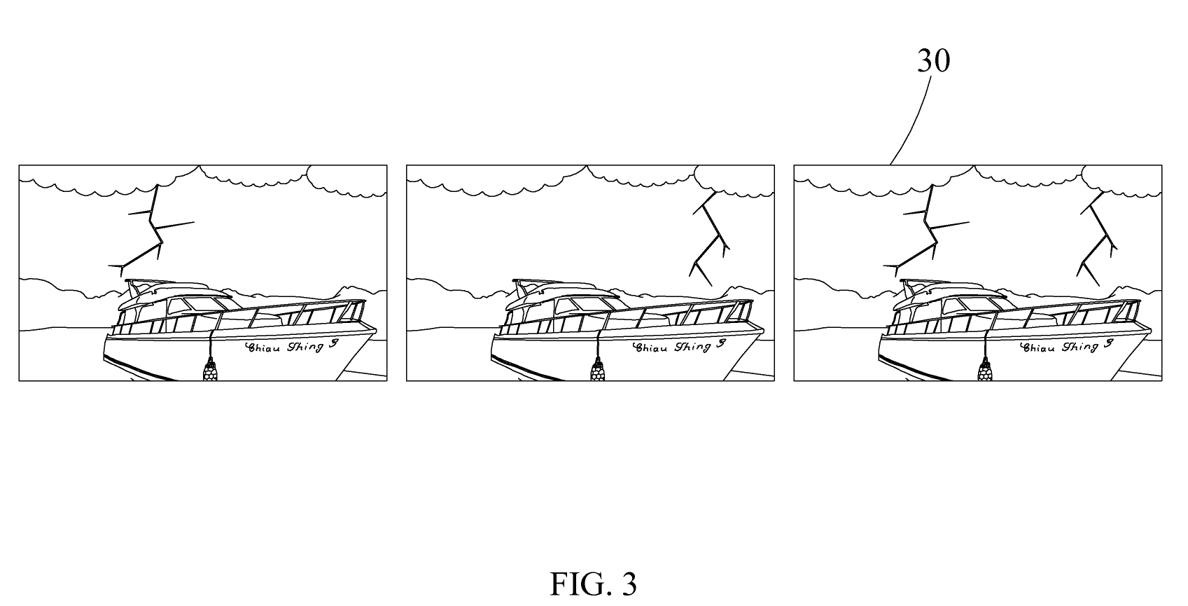

With reference to FIG. 3 for a schematic diagram of an image capturing device in accordance with another embodiment of the invention is depicted. As shown in FIG. 3, when the user would like to take the scene having lightning, the setting module 12 can be utilized to set a threshold value 120 such that when the brightness value variation is greater than the threshold value 120, the processing module 14 controls the image capturing module 10 to capture a plurality of temporary images and performs image synthesis for the plurality of temporary images such that the image having the brightness value variation produced at a time spot within a period of time can be superposed to become a synthesized image 30. As shown in the figure, the scene has multiple lightning. The user can set a threshold value to allow the processing module 14 to automatically determine whether or not a plurality of temporary images is captured corresponding to the scene. If the processing module decides that the plurality of temporary images is captured corresponding to the scene. Further, the plurality of temporary images can be superposed to allow the user to obtain the synthesized image 30 having multiple lightning within a period of time. It should be noted that in a process of superposing the temporary images, when the temporary image that is unable to accurately superpose another temporary image, or the temporary image is unable to superpose another temporary image in case of a variation of partial object in the temporary image that is too much, the image capturing device 1 can superpose the temporary image capable of being accurately superposed. For example, a portion of the sensing scope of each image is superposed, and a portion of the sensing scope that is not sensed is ignored to accelerate the speed of processing images.

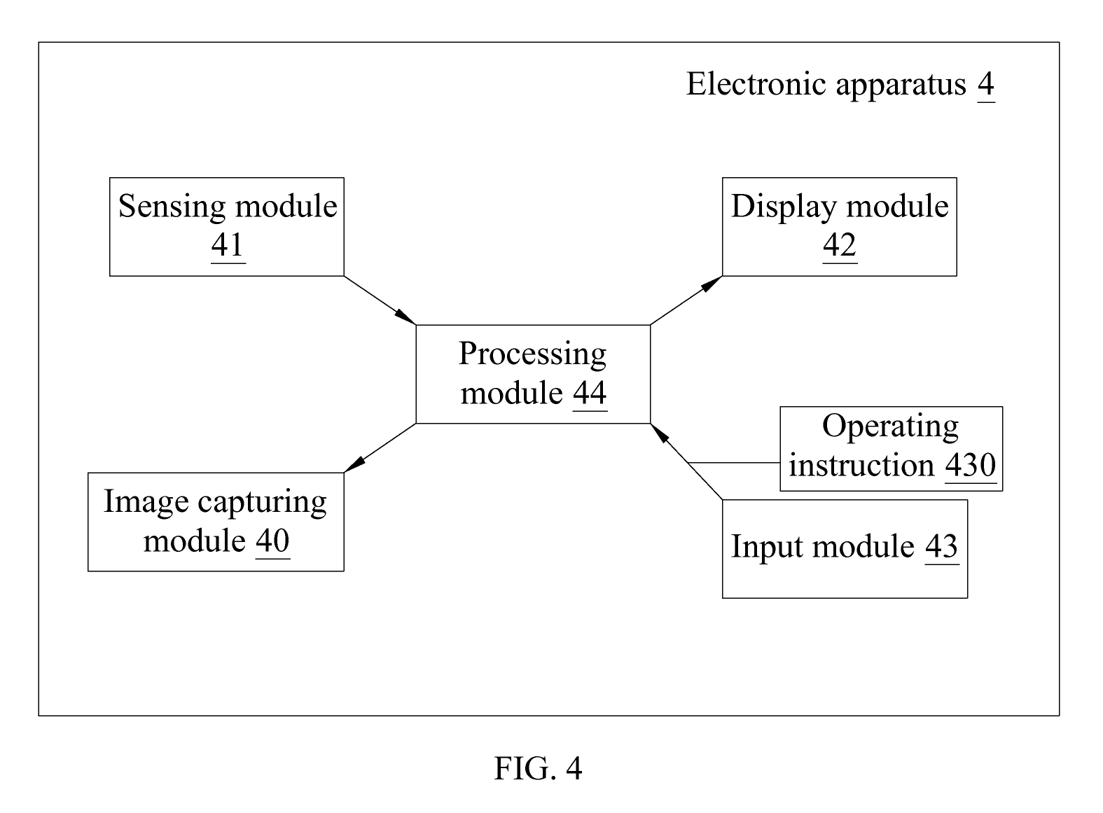

With reference to FIG. 4 for a block diagram of an electronic apparatus in accordance with an embodiment of the invention is depicted. As shown in FIG. 4, the electronic apparatus 4 of the invention comprises an image capturing module 40, a sensing module 41, a display module 42, an input module 43 and a processing module 44. The image capturing module 40 is provided for capturing an image corresponding to a scene. The sensing module 41 senses a brightness value of the scene. The display module 42 displays a capturing frame captured by the image capturing module 40. The input module 43 provides an operating instruction 430 to the processing module 44 after operating by a user. The processing module 44 is electrically connected to the image capturing module 40, the sensing module 41, the display module 42 and the input module 43. The processing module 44 divides the capturing frame into a plurality of blocks based upon the operating instruction 430 and controls the sensing module 41 to decide whether or not the brightness value of any one block is changed. When the brightness value of any one block is changed, the processing module 44 controls the image capturing module 40 to capture the image. The image automatically captured by the electronic apparatus 4 of the invention has been depicted in the foregoing image capturing device 1, and there is no need to repeat herein.

In the embodiment, the electronic apparatus 4 can be an intelligent mobile phone, wherein its display module 42 and the input module 43 can be an integrated touch screen. In addition, those skilled in the art will understand that the spirit of the invention can be implemented in the mobile phone and the intelligent mobile phone having picture taking function, the personal digital assistant having picture taking function, the navigator having picture taking function or the tablet computer or laptop computer having picture taking function.

Although a concept of a method for automatically capturing images of the invention has been simultaneously depicted in the process of describing the image capturing device of the invention, the following is a flowchart to clearly depict the method.

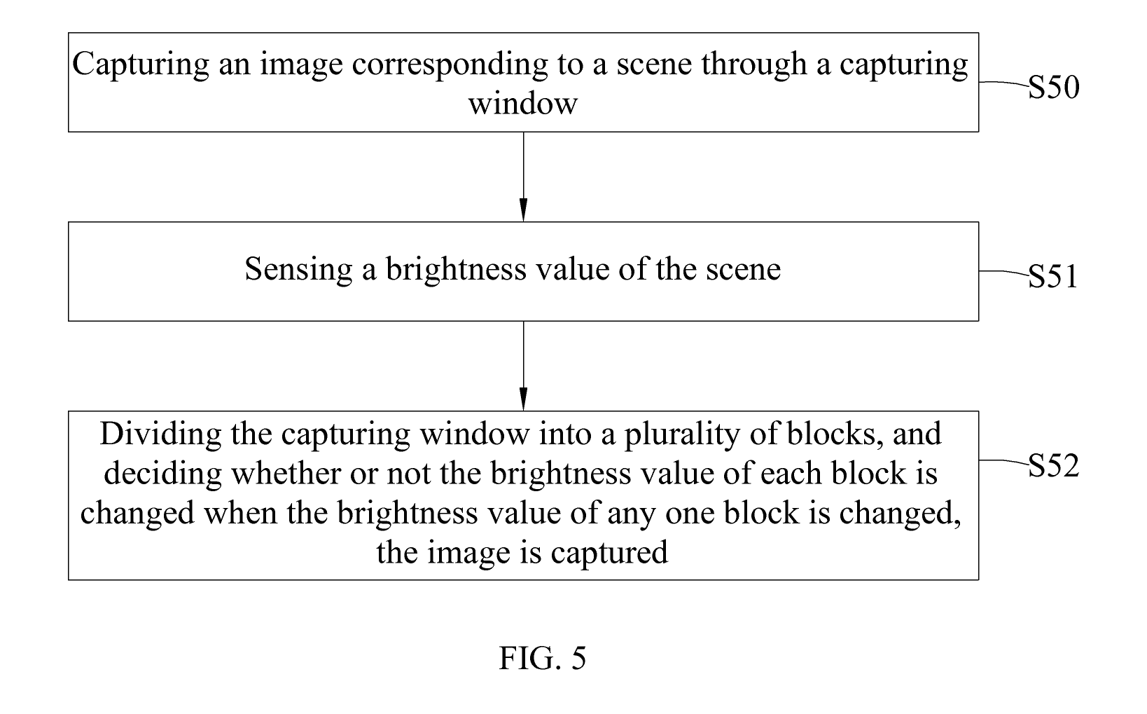

With reference to FIG. 5 for a first flowchart of a method for automatically capturing images in accordance with the invention is depicted. As shown in FIG. 5, the method for automatically capturing images comprises the following steps:

S50: Capturing an image corresponding to a scene through a capturing window;

S51: Sensing a brightness value of the scene;

S52: Dividing the capturing window into a plurality of blocks, and deciding whether or not the brightness value of each block is changed, when the brightness value of any one block is changed, the image is captured.

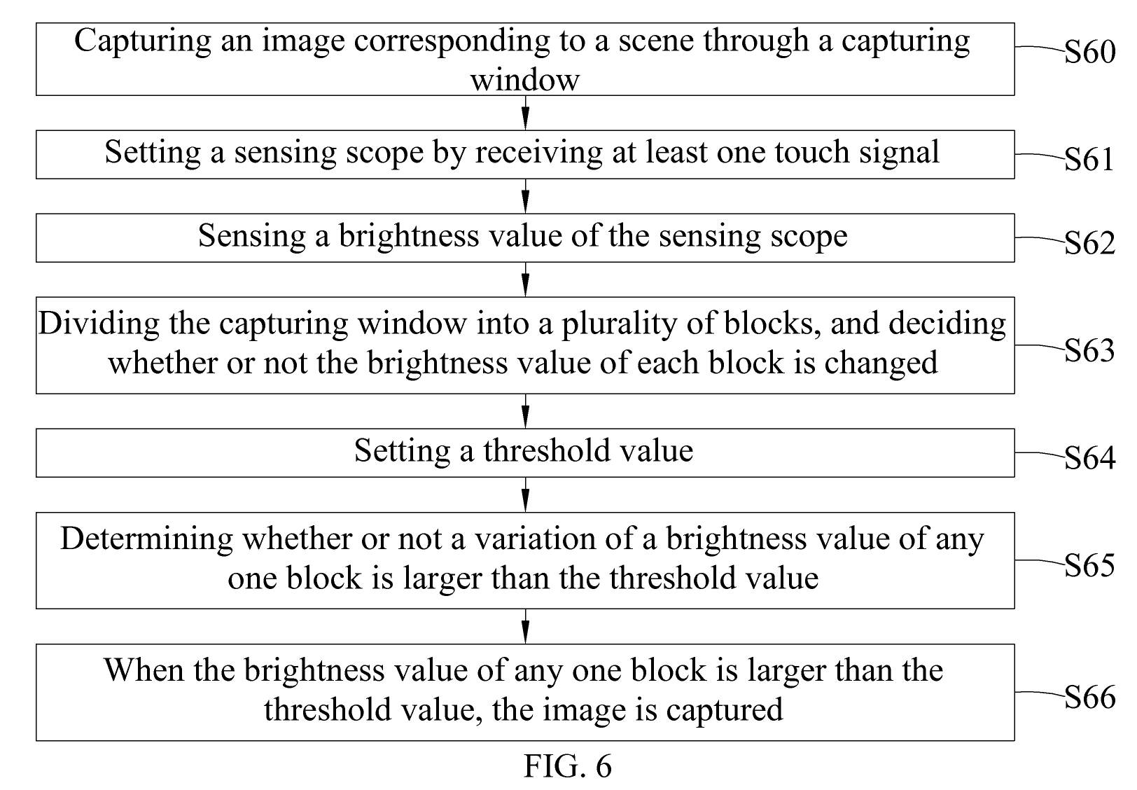

With reference to FIG. 6 for a second flowchart of a method for automatically capturing images is depicted in accordance with the invention. As shown in FIG. 6, the method for automatically capturing images comprises the following steps:

S60: Capturing an image corresponding to a scene through a capturing window;

S61: Setting a sensing scope by receiving at least one touch signal;

S62: Sensing a brightness value of the sensing scope;

S63: Dividing the capturing window into a plurality of blocks, and deciding whether or not the brightness value of each block is changed;

S64: Setting a threshold value;

S65: Determining whether or not a variation of a brightness value of any one block is larger than the threshold value;

S66: When the brightness value of any one block is larger than the threshold value, the image is captured.

The method for automatically capturing images can further perform image synthesis for the plurality of temporary images so that an image, which has a variation of the brightness value within a certain time, generated at time spot can be superposed into a synthesized image. The depiction and the embodiments of the method for automatically capturing images of the invention have been depicted in the forgoing image capturing device of the invention, and there is no need to depict herein.

To sum up, the electronic apparatus, the image capturing device and its method for automatically capturing images can respectively sense the brightness and the brightness variation by dividing the capturing window into a plurality of blocks or further catch any one block of the capturing window to form a sensing scope so that the user can select the sensing scope to sense the brightness variation (e.g. sky) within a specific area of the scene. When the brightness value of any one block is changed, the image is automatically captured such that the user can obtain a brightness variation in a scene. Preferably, by setting a threshold value, the processing module can determine controlling the image capturing module to capture images. The electronic apparatus, the image capturing device and its method for automatically capturing images can automatically determine the brightness variation taken by the user to automatically capture images.

The present invention has been described with some preferred embodiments thereof and it is understood that many changes and modifications in the described embodiments can be carried out without departing from the scope and the spirit of the invention that is intended to be limited only by the appended claims

What is claimed is:

1. An image capturing device comprising:
an image capturing module utilizing a capturing window to capture an image corresponding to a scene;
a sensing module capable of sensing a brightness value of the scene;
a processing module capable of dividing the capturing window into a plurality of blocks and controlling the sensing module to decide whether or not the brightness value of each block is changed, wherein when the brightness value of any one block is changed, the processing module controls the image capturing module to capture the image.

2. The image capturing device as recited in claim 1, further comprising a setting module electrically connected to the processing module, wherein the setting module sets a threshold value, and when a brightness variation of any one block is larger than the threshold value, the processing module controls the image capturing module to capture the image.

3. The image capturing device as recited in claim 2, wherein when the brightness variation is larger than the threshold value, the processing module controls the image capturing module to capture a plurality of temporary images and performs image synthesis for the plurality of temporary images.

4. The image capturing device as recited in claim 2, wherein the setting module further sets a sensing scope, and the sensing module sense the brightness value of the sensing scope, and the processing module divides the sensing scope into a plurality of blocks, and when the brightness value of any one block is changed, the processing module controls the image capturing module to capture the image.

5. The image capturing device as recited in claim 4, further comprising a touch module electrically connected to the setting module, wherein the touch module receives at least one touch signal to allow the setting module to set the sensing scope based upon the touch signal.

6. An electronic apparatus comprising:
an image capturing module capable of capturing an image corresponding to a scene;
a sensing module capable of sensing a brightness value of the scene;
a display module capable of displaying a captured frame;
an input module operated to provide an operating instruction;
a processing module electrically connected to the image capturing module, the sensing module, the input module and the display module, wherein the processing module divides the capturing frame into a plurality of blocks based upon the operating instruction and controlling the sensing module to decide whether or not the brightness value of any one block is changed, when it is decided that the brightness value of any one block is changed, the processing module controls the image capturing module to capture the image.

7. A method for automatically capturing images applied to an image capturing device, the method for automatically capturing images comprising the steps of:
capturing an image corresponding to a scene through a capturing window;
sensing a brightness value of the scene;
dividing the capturing window into a plurality of blocks and sensing whether or not the brightness value of each block is changed, wherein when the brightness value of any one block is changed, capturing the image.

8. The method for automatically capturing images as recited in claim 7, further comprising the steps of:
setting a threshold value and capturing the image when brightness variation of any one block is larger than the threshold value.

9. The method for automatically capturing images as recited in claim 8, further comprising the steps of:
capturing a plurality of temporary images when the brightness variation is larger than the threshold value and performing an image synthesis for the plurality of temporary images.

10. The method for automatically capturing images as recited in claim 7, further comprising the steps of:
setting a sensing scope and
sensing the brightness value of the sensing scope.
